(19) United States
(12) Patent Application Publication
(10) Pub. No.: US 2010/0036866 A1
(43) Pub. Date: Feb. 11, 2010

(54) Piping Circuitization System and Method

(75) Inventor: Ryan Sitton, Pearland, TX (US)

Correspondence Address: KRUEGER ISELIN LLP (SC), P O BOX 1906, CYPRESS, TX, 77410-1906, US

(73) Assignee: PinnacleAIS, LLC, Pearland, TX (US)

(21) Appl. No.: 12/189,339

(22) Filed: Aug. 11, 2008

(51) Int. Cl. G06F 17/30; G06F 3/048

(52) U.S. Cl. 707/102; 715/771; 715/709; 707/E17.018; 707/E17.019

(57) ABSTRACT

In a disclosed method for creating a pipe circuit, a diagram is displayed on a display screen. The diagram includes representations of multiple pipes to be included in the pipe circuit, and a line number corresponding to each of the pipes. Selection input indicative of each of the pipes is received in sequence, and the pipe circuit is assigned a pipe circuit number. A described computer system includes a display screen, a memory, and one or more processors. The memory contains instructions for: displaying the diagram on the display screen, parsing the line numbers to capture engineering data for the pipe circuit, changing a display color of each of the representations of the pipes to a selected color, and exporting information about each of the pipes in the pipe circuit to a database. The processor(s) fetch the instructions from the memory and execute the instructions.

### BACKGROUND

Many industrial plants employ one or more systems of heaters, boilers, mixers, compressors, reactors, towers, exchangers, filters, tanks, and/or other units, which may be interconnected by a system of pipes, pumps, manifolds, regulators, valves, electronic controls, and instrumentation. A “piping and instrumentation diagram” (P&ID or PID) provides a schematic representation of the arrangement and interconnection of this equipment. A P&ID is often also called an “engineering flow sheet” or “engineering line diagram.” P&IDs are often regarded as fundamental representations of processes involving fluids (liquids and/or gases).

Computer assisted design (CAD) software is widely used in plant design and the generation of P&IDs. AutoCAD® (a commercially available product from Autodesk, Inc., San Rafael, Calif.) is one of the oldest and most popular CAD programs. Other CAD programs used in the design of piping systems include the SolidWorks three-dimensional (3D) CAD software developed by the SolidWorks Corporation (Concord, Mass.). Such software products often come with “add-in” or “plug-in” applications, i.e., software utilities that can be added to a primary program. Plug-in programs have been developed to work with CAD systems to provide, for example, custom objects that can be added to a drawing.

To support the development of independent plug-in programs, Autodesk, Inc., has adopted an open architecture for its AutoCAD® program. AutoCAD® currently supports a number of application programming interfaces (APIs) for customization, including ObjectARX® (Autodesk, Inc.), .NET, Visual Basic® for Applications (Microsoft Corp., Redmond, Wash.), AutoLISP, and Visual LISP. For example, the ObjectARX® API provides object-oriented C++, C#, and Visual Basic® .NET application programming interfaces for developers to use, customize, and extend AutoCAD® software. Known AutoCAD® plug-in applications for piping design include the AutoPLANT Piping software (Bentley Systems, Inc., Exton, Pa.), the CADWorx P&ID software (COADE, Inc., Houston, Tex.), and the PipeDesigner 3D software (QuickPen International, Timonium, Md.). The SolidWorks Corporation has also adopted an open architecture for the SolidWorks 3D CAD program, and the SolidWorks 3D CAD software currently provides an API for custom programming in the Visual Basic® and C programming languages. The SolidWorks Corporation currently offers the SolidWorks Piping add-in for the SolidWorks 3D CAD software.

Irrespective of whether they have been generated manually or with computer aided drafting, P&IDs provide a comprehensive representation of the plant or process unit. In a P&ID, all equipment items, pipes, valves, and instruments are typically assigned unique identifiers according to a standard system for generating identifiers. On the P&ID, the unique identifiers are typically placed next to the corresponding equipment items, pipes, valves, and instruments. Identifiers assigned to equipment items are commonly called “equipment numbers,” identifiers assigned to pipes are called “line numbers,” and identifiers assigned to valves and instruments are called “identification numbers.” Special symbols are typically used to represent the equipment items, pipes, valves, and instruments to indicate the types of the equipment items, pipes, valves, and instruments.

Systems for generating unique identifiers for equipment items, pipes, valves, and instruments differ from organization to organization. One common system involves assigning line numbers to pipes according to the ‘SIZE-SERVICE-NUMBER-SPEC’ format, where the ‘SIZE’ parameter identifies the diameter of the pipe, the ‘SERVICE’ parameter identifies the type of service provided by fluid carried in the pipe, the ‘NUMBER’ parameter identifies a unique number assigned to the pipe, and the ‘SPEC’ parameter identifies the specification document that details the characteristics of the pipe. For example, in a line number ‘6″-P-30506-AA9E’ assigned to a pipe according to the SIZE-SERVICE-NUMBER-SPEC format, the SIZE parameter is ‘6’′ indicating that the pipe has a diameter of 6 inches, the ‘SERVICE’ parameter is ‘P’ indicating that the fluid carried by the pipe provides a main process service, the ‘NUMBER’ parameter is ‘30506’ indicating the unique number assigned to the pipe, and the ‘SPEC’ parameter is ‘AA9E’ indicating that the pipe is made of steel meeting the American Society for Testing and Materials (ASTM) standard A9 and is suitable for certain operating conditions of temperature and pressure. The size, service, and spec values are examples of a broader class of engineering data that identify the design parameters of the pipe.

Industrial plants are often manually “circuitized” to facilitate inspection, maintenance, and/or repair. As used herein, the term “circuit” is a set of one or more system elements that is treated as a basic unit for inspection and maintenance purposes, and “circuitization” is the process of segregating the various networks of pipe into circuits and identifying all of the applicable circuit parameters for a plant or process unit. At least one known piping circuitization method employs manual marking of a P&ID to identify circuits. The circuits are chosen in a manner designed to minimize the total number of circuits subject to certain restrictions. One such restriction is that all the pipes in a single circuit must carry the same process fluid and share the same specification. Another such restriction is that circuits should have logical start and end points (e.g., at equipment items or landmarks that aid in locating the circuits in the field). Because P&IDs often span many large sheets of paper and often include thousands of system elements with their corresponding identifiers, the circuitization process is usually tedious and time consuming.

### SUMMARY

The problems identified above are at least partly addressed by a piping circuitization system and method described herein. In a disclosed method for creating a pipe circuit, a diagram is displayed on a display screen. The diagram includes representations of multiple pipes to be included in the pipe circuit, and a line number corresponding to each of the pipes. Selection input indicative of each of the pipes is received in sequence, and the pipe circuit is assigned a pipe circuit number. The method may also include converting at least one of the line numbers to a new data format. The converting may include: receiving input indicative of a current data format of a selected one of the line numbers, receiving input indicative of a new data format of the selected line number, and converting the selected line number from the current data format to the new data format.

The method may also include receiving input indicative of a color in which the representations of the pipes of the pipe circuit are to be displayed, and/or saving the diagram. The method may also include exporting information about each of the pipes in the pipe circuit to a database. The database may include a spreadsheet file.

A described computer system includes a display screen, a memory, and one or more processors. The memory contains instructions for: displaying the above described diagram on the display screen, converting at least one of the displayed line numbers to a new data format, changing a display color of each of the representations of the pipes to a selected color, and exporting information about each of the pipes in the pipe circuit to a database. The one or more processors are coupled to the memory and configured to fetch the instructions from the memory and to execute the instructions.

### BRIEF DESCRIPTION OF THE DRAWINGS

A better understanding of the various disclosed embodiments can be obtained when the detailed description is considered in conjunction with the following drawings, in which:

FIG. 1 shows an illustrative circuitization system embodiment;

FIG. 2 shows a block diagram of the illustrative system of FIG. 1;

FIG. 3 shows illustrative software components that may reside in the memory of a circuitization system;

FIG. 4 shows an illustrative piping and instrumentation diagram (P&ID);

FIG. 5 is an image of a portion of the P&ID of FIG. 4 displayed on the display screen;

FIG. 6 is an enlarged view of a circuitization toolbar located in a lower left hand portion of the image of FIG. 5;

FIG. 7 is a view of an illustrative ‘Source Line Tag’ dialog box displayed on the display screen;

FIG. 8 is a subsequent view of the ‘Source Line Tag’ dialog box of FIG. 9;

FIG. 9 is another subsequent view of the ‘Source Line Tag’ dialog box of FIG. 9;

FIG. 10 shows the P&ID view of FIG. 5 with a new line number;

FIG. 11 shows an illustrative ‘Circuit’ dialog box;

FIG. 12 shows an illustrative color palette dialog box;

FIG. 13 shows an illustrative ‘Create Script File’ dialog box;

FIG. 14 shows an illustrative ‘Select DWG Files’ dialog box;

FIG. 15 shows an illustrative exported circuitization file; and

FIGS. 16A-16B in combination form a flowchart of an illustrative method for creating a pipe circuit.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

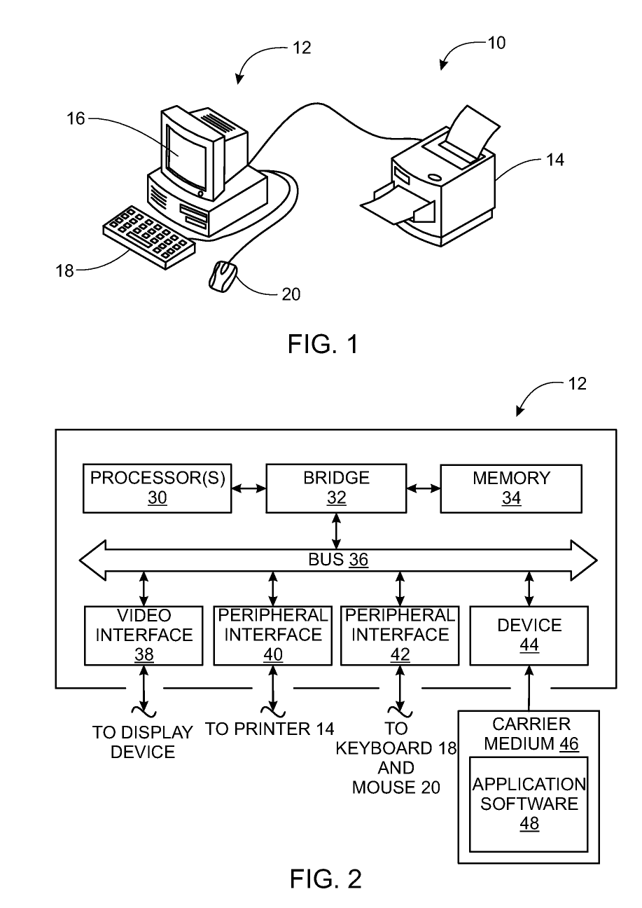

To facilitate the circuitization of piping and instrumentation diagrams (P&IDs), there is disclosed herein a software utility that automates portions of the circuitization process and enables the circuitization information to be captured in multiple formats for different potential uses. To begin with, FIG. 1 shows an illustrative circuitization system 10 embodied as a desktop computer configured with suitable software. In the embodiment of FIG. 1, the system 10 includes a computer system 12 coupled to a printer 14. The computer system 12 includes a display screen 16, a keyboard 18, and a mouse 20.

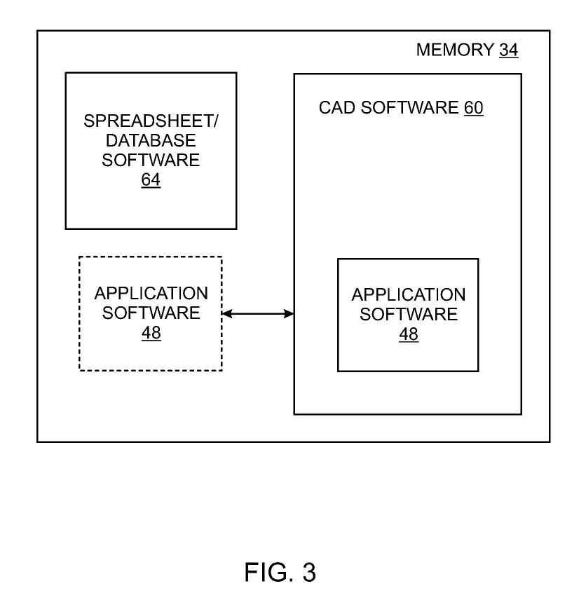

FIG. 2 is a diagram of one embodiment of the computer system 12 of FIG. 1. In the embodiment of FIG. 2, the computer system 12 includes one or more processor(s) 30 and a memory 34 coupled to a bridge 32. The processor(s) 30 access the memory 34 via the bridge 32, obtain instructions from the memory 34, and execute the instructions. The bridge 32 is coupled to a bus 36, and forms an interface to the bus 36. A video interface 38 (e.g., a video card) is coupled to the bus 36, and to the display device. The processor(s) 30 send information to the display device via the bridge 32, the bus 36, and the video interface 38.

A first peripheral interface 40 is coupled between the bus 36 and the printer 14. The processor(s) 30 send information to the printer 14 via the bridge 32, the bus 36, and the peripheral device 40. A second peripheral interface 42 is coupled to the bus 36, the keyboard 18, and the mouse 20. The processor(s) 30 receive information from the keyboard 18 and the mouse 20 via the bridge 32, the bus 36, and the peripheral device 42.

A information storage device 44 is coupled to the bus 36, and adapted to receive a information storage medium 46 having application software 48 stored thereon or therein. The application software 48 includes program instructions which, when executed by the processor(s) 30, cause the processor(s) 30 to carry out steps of a piping circuitization method. When the information storage medium 46 is inserted in the information storage device 44, the program instructions of the application software 48 may be copied or transferred from the information storage medium 46 to the memory 34. The device 44 may be, for example, a floppy disk drive, and the information storage medium 46 may be a floppy disk. Alternatively, the device 44 may be a compact disk read only memory (CD-ROM) drive, and the information storage medium 46 may be a CD-ROM. Further still, the device 44 may be or include a universal serial bus (USB) port, and the information storage medium 46 may be a USB flash memory drive.

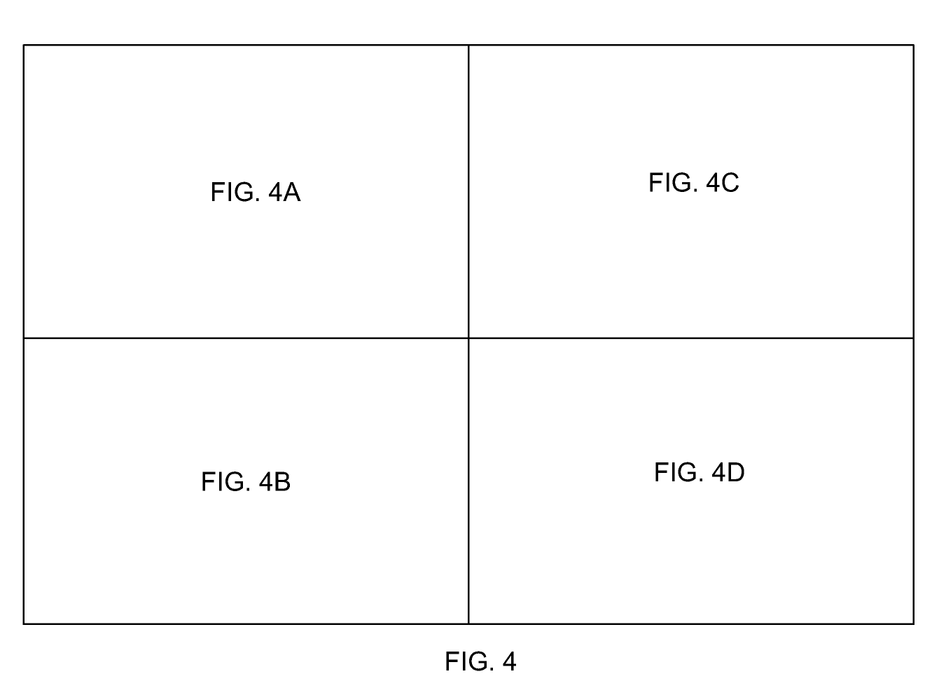

FIG. 3 is a diagram of illustrative software components that may reside in memory 34 of FIG. 2. In the embodiment of FIG. 3, the software components include the application software 48, computer-aided design (CAD) software 60, and spreadsheet or database software 64. In the embodiment of FIG. 3, the application software 48 is part of the CAD software 60 (as indicated by the application software 48 in a box with solid lines located within the CAD software 60). For example, the application software 48 may be an add-in or plug-in application added to the CAD software 60. In other embodiments, the application software 48 may be separate from the CAD software 60 (as indicated by the application software 48 in a box with dashed lines located outside of the CAD software 60), and may communicate with the CAD software 60 during execution. The CAD software 60 may be, for example, the AutoCAD® software developed by Autodesk, Inc. (San Rafael, Calif.). Other suitable CAD software is commercially available.

In the embodiments described herein, the application software 48 adds piping circuitization capability to the CAD software 60. With the aid of the application software 48, the CAD software 60 creates one or more drawing files containing information about each element of one or more pipe circuits. The application software 48 accesses the one or more drawing files, and creates and saves (i.e., exports) a spreadsheet or database file containing the information about each pipe in the one or more pipe circuits in a format readable by the spreadsheet or database software 64. The spreadsheet or database software 64 is used to access the spreadsheet or database file exported by the application software 48.

In some embodiments, the spreadsheet or database software 64 is or includes the Microsoft Excel® spreadsheet program (Microsoft Corp., Redmond, Wash.). The application software 48 accesses the one or more drawing files, and exports an Excel® compatible spreadsheet file containing the information about each pipe in the one or more pipe circuits. The spreadsheet or database software 64 is used to access the Excel® compatible spreadsheet file exported by the application software 48.

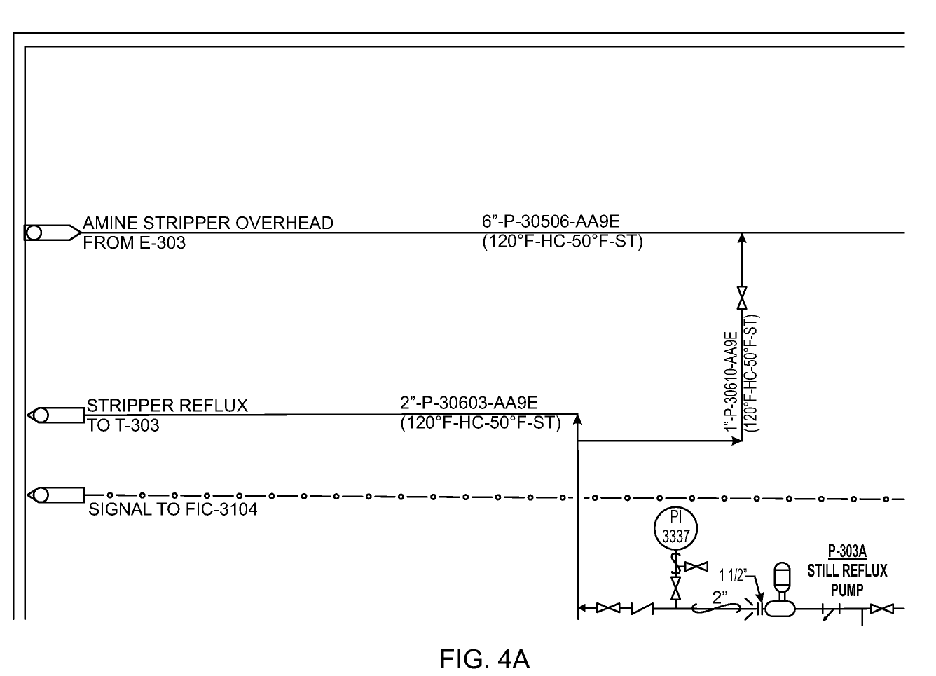

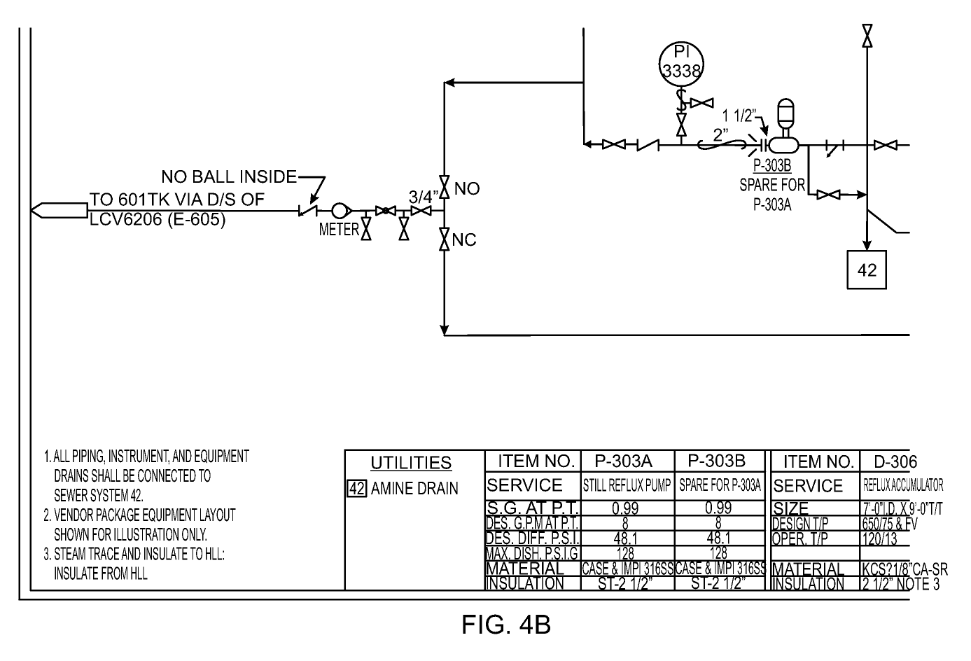

FIGS. 4-15 will now be used to describe illustrative piping circuitization methods that may be carried out by system 10. FIG. 4 is a view of an exemplary piping and instrument diagram (P&ID) that will be used for illustrating the circuitization methods. In the P&ID of FIG. 4, solid lines are used to represent pipes, and each pipe has a line number adjacent the pipe. The CAD software 60 may configure the processor(s) 30 to display the P&ID on the display screen 16 as shown in FIG. 5. In FIG. 5, the displayed portion of the P&ID includes a solid line representing a pipe to be included in the pipe circuit. The line number corresponding to the pipe is adjacent the pipe, and is ‘6″-P-30506-AA9E.’

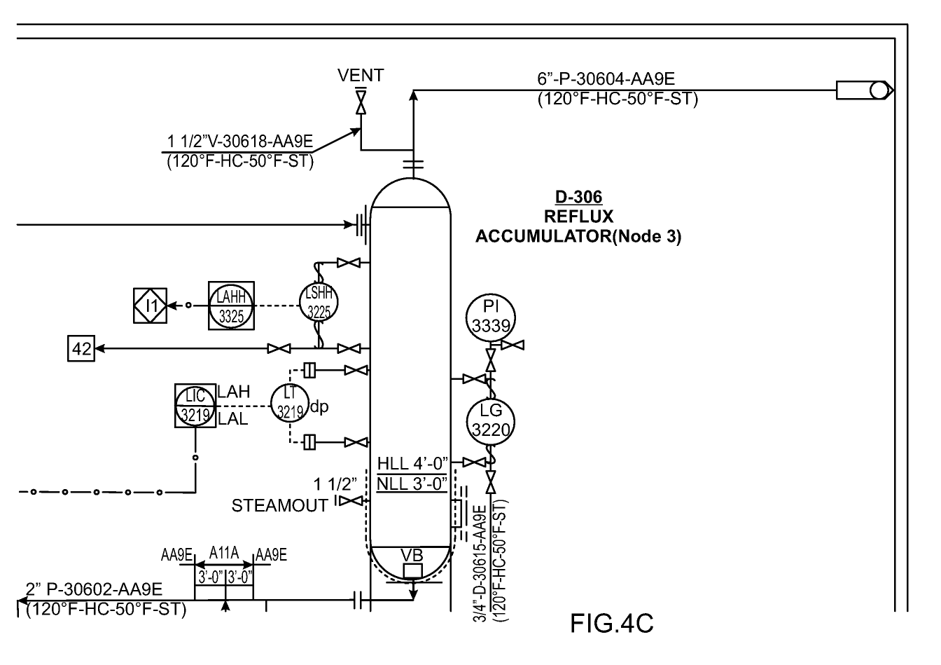

Line numbers of pipes to be included in the pipe circuit and not in a desired new data format are first converted from a current data format to the new data format. This step (if needed) simplifies the extraction of engineering data relevant to the circuit. FIGS. 6-10 will be used to describe the line number conversion process. FIG. 6 is an enlarged view of a circuitization toolbar 70 located in a lower left hand portion of the image of FIG. 5. The circuitization toolbar 70 is displayed on the display screen 16 as the processor(s) 30 of FIG. 2 execute instructions of the application software 48 of FIG. 3. In the embodiment of FIG. 6, the circuitization toolbar 70 includes a ‘Convert Line Number’ button 72, a ‘Circuitize’ button 74, and an ‘Export All Lines Info’ button 76.

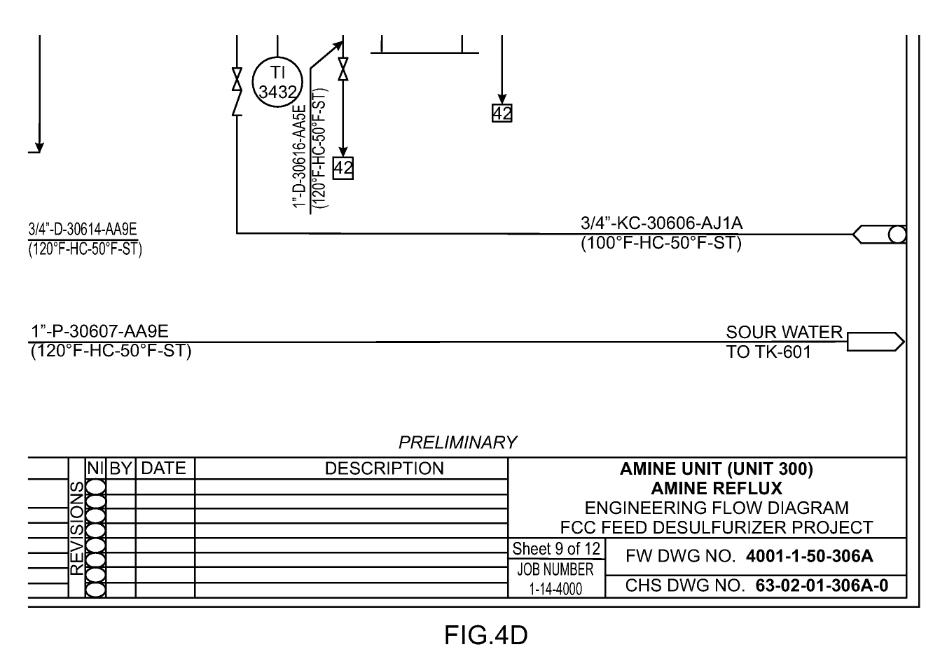

If any of the line numbers of pipes to be included in the pipe circuit are not in the desired new data format, the user selects the ‘Convert Line Number’ button 72 on the circuitization toolbar 70 to initiate the line number conversion process. In this example, the line number ‘6″-P-30506-AA9E’ that has been selected in FIG. 5 is to be converted from the current ‘SIZE-SERVICE-NUMBER-SPEC’ format to a new format. When the user selects the ‘Convert Line Number’ button 72 on the circuitization toolbar 70, instructions of the application software 48 cause the processor(s) 30 to display information that prompts the user to select a line number, if one has not already been selected. Once a number has been selected, the software displays a ‘Source Line Tag’ dialog box as shown in FIG. 7. The selected line number ‘6″-P-30506-AA9E’ appears in a ‘Source Line Tag’ field of the dialog box. When the user selects the line number format from the format list on a right side of the dialog box, the software parses the line number to determine data for the corresponding pipe and displays it in the fields on a left side of the dialog box. The values shown in FIG. 7 appear after the user has selected the ‘PRSI’ format as the current data format. If desired, the user can add values in the unpopulated fields to provide additional information regarding the current pipe.

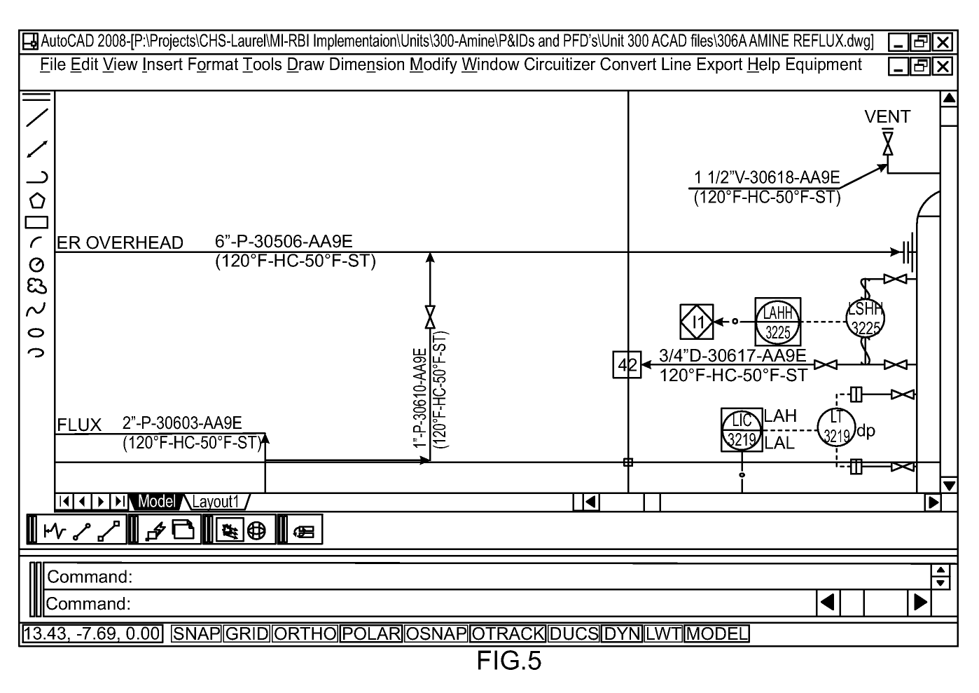

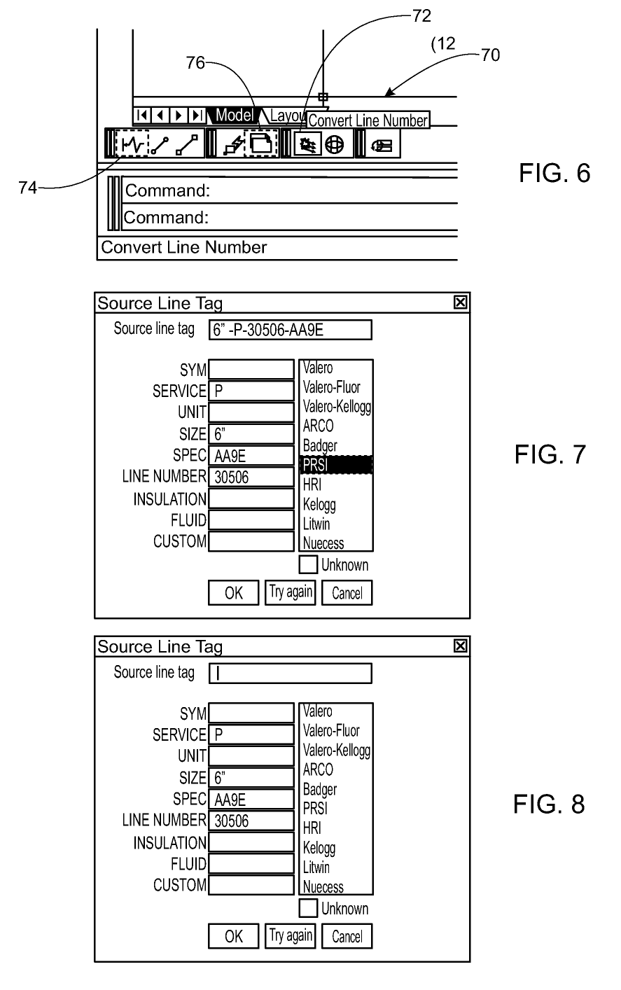

FIG. 8 is a view of the ‘Source Line Tag’ dialog box of FIG. 7 after the user has selected an ‘OK’ button at the bottom of the dialog box. In FIG. 8, the ‘Source Line Tag’ field has changed to an empty ‘Target Line Tag’ field. The data of the corresponding pipe remains displayed in the fields on the left side of the dialog box. When the user selects the new data format from the format list on the right side of the dialog box, the processor(s) 30 of FIG. 2, executing instructions of the application software 48 of FIG. 3, use the data displayed in the fields on the left side of the dialog box to generate a new line number for the corresponding pipe dependent upon the selected new data format. FIG. 9 shows the ‘Source Line Tag’ dialog box of FIG. 8 after the user has selected the ‘PRSI’ format as the new data format, resulting in the generation of a new line number ‘6″-P-30506-AA9E’ and display of the new line number in the ‘Target Line Tag’ field. (In this simple example, the new line number is the same as the original line number as the new data format is the same as the old data format. Nevertheless, the software is now “aware” of how to parse the line numbers.)

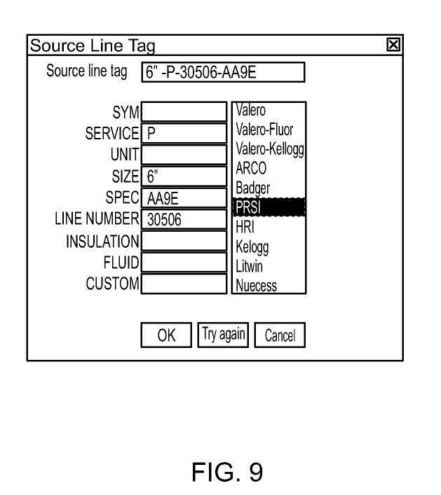

FIG. 10 shows the new line number displayed on the display screen 16 in place of the old line number adjacent the corresponding pipe in the P&ID after the user has selected the new data format and the ‘OK’ button at the at the bottom of the ‘Source Line Tag’ dialog box. (Again, in this simple example the new displayed line number is the same as the originally displayed line number as the new data format is the same as the old data format, but the software has now parsed the line data.) The above line number conversion process is carried out for all line numbers of pipes to be included in the pipe circuit and not in the new data format.

As described above, the circuitization toolbar 70 shown in FIG. 6 includes a ‘Circuitize’ button 74. After the line numbers of pipes to be included in the pipe circuit have been parsed and optionally converted to the new data format, the user selects the ‘Circuitize’ button 74 on the circuitization toolbar 70. As a result, the word ‘COMMANDLINE’ is displayed next to ‘Command:,’ prompting the user to select in sequence on the display screen 16 each of the lines on the displayed P&ID representing the pipes to be included in the pipe circuit.

As each line representing one of the pipes to be included in the pipe circuit is selected by the user, a wider, dashed line is layered on top of the original line until the circuitization is complete. This makes it easy for the user to tell which lines have been selected. After selecting all the lines representing the pipes to be included in the pipe circuit in sequence, the user signals completion of the selection process by pressing the ‘Enter’ key on the keyboard 18 (see FIG. 1).

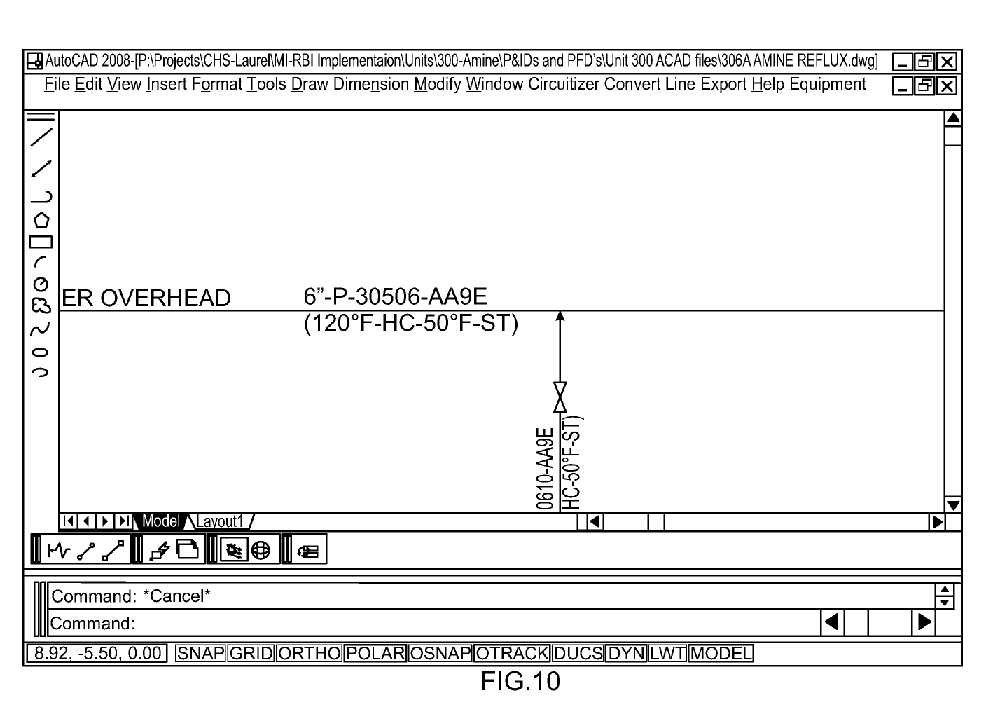

FIG. 11 shows a ‘Circuit’ dialog box displayed on the display screen 16 after the user has selected all the lines representing the pipes to be included in the pipe circuit and has pressed the ‘Enter’ key on the keyboard 18. The user enters a number to be assigned to the pipe circuit in a text box, then selects the ‘OK’ button at the bottom of the dialog box.

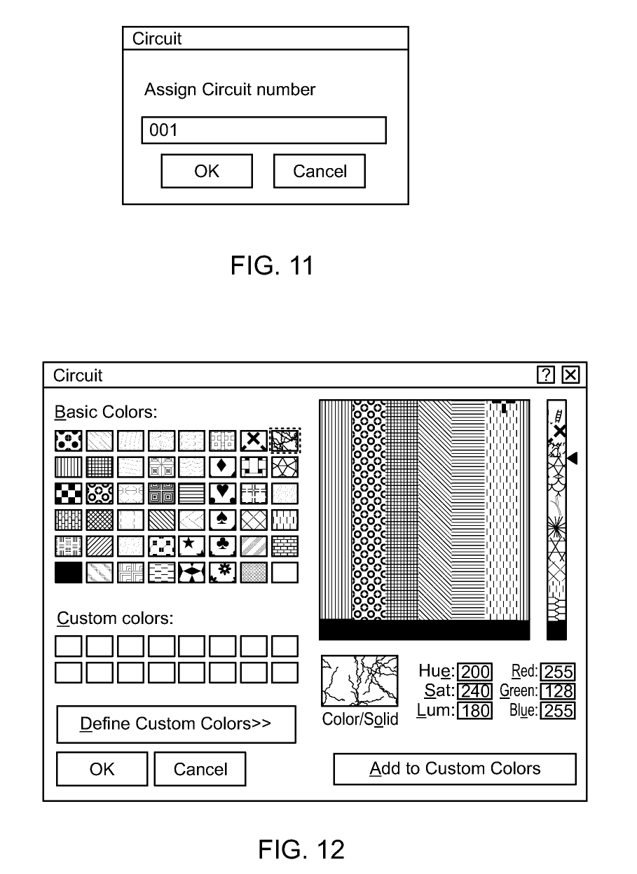

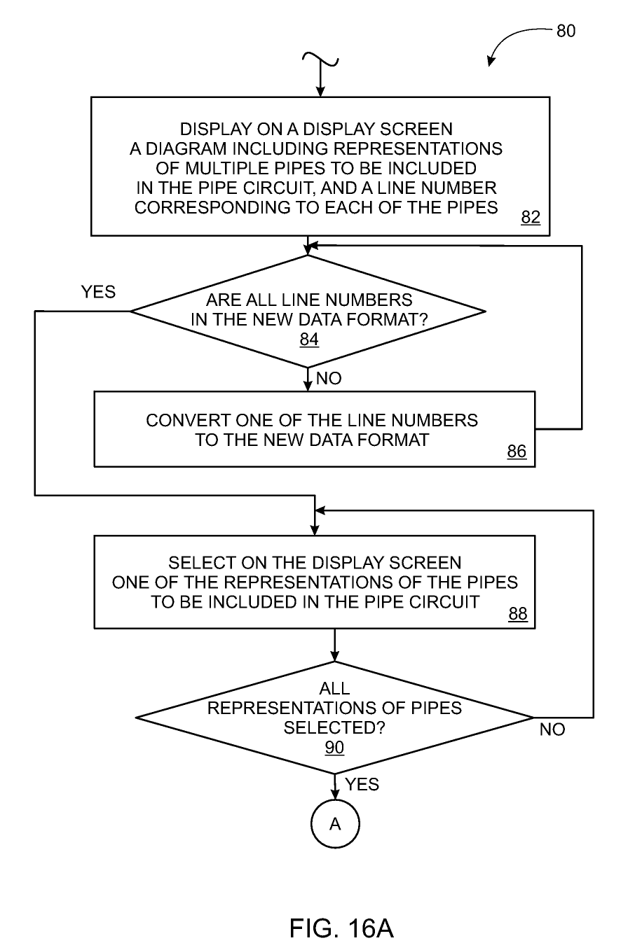

After the user enters the circuit number, the user selects a color for the displayed lines representing the pipes of the pipe circuit. FIG. 15 shows a color palette displayed in the ‘Circuit’ dialog box of FIG. 12 after the user has entered a number to be assigned to the pipe circuit in a text box, and has selected the ‘OK’ button at the bottom of the dialog box. The user selects one of many colors displayed in the color palette, then selects the ‘OK’ button at the bottom of the dialog box. After the user selects the color of the displayed lines representing the pipes of the pipe circuit and selects the ‘OK’ button, the colors of the lines are changed to the selected color in the P&ID display. Each line in the pipe circuit now has an assigned display color and an assigned circuit number associated with it. Moreover, the circuitization software has extracted the relevant engineering data for the circuit from the line numbers associated with each of the pipes in the pipe circuit. The software captures the circuit information in an internal data structure, which links the graphical representation of the circuit with the engineering data, line numbers, and individual drawing lines making up the circuit.

The above circuit selection process may be repeated for any additional pipe circuits in the P&ID. Once the circuit selection process is completed, the drawing is saved in the memory 34 or on an information storage device (as a drawing file via the CAD software 60 of FIG. 3). As a result, information about each pipe of the pipe circuits is stored in the drawing file.

As described above, the circuitization toolbar 70 shown in FIG. 6 includes an ‘Export All Lines Info’ button 76. When the user selects the ‘Export All Lines Info’ button 76, the captured information about each pipe of the pipe circuits is exported to a file in a format readable by the spreadsheet or database software 64 of FIG. 3, as described further below.

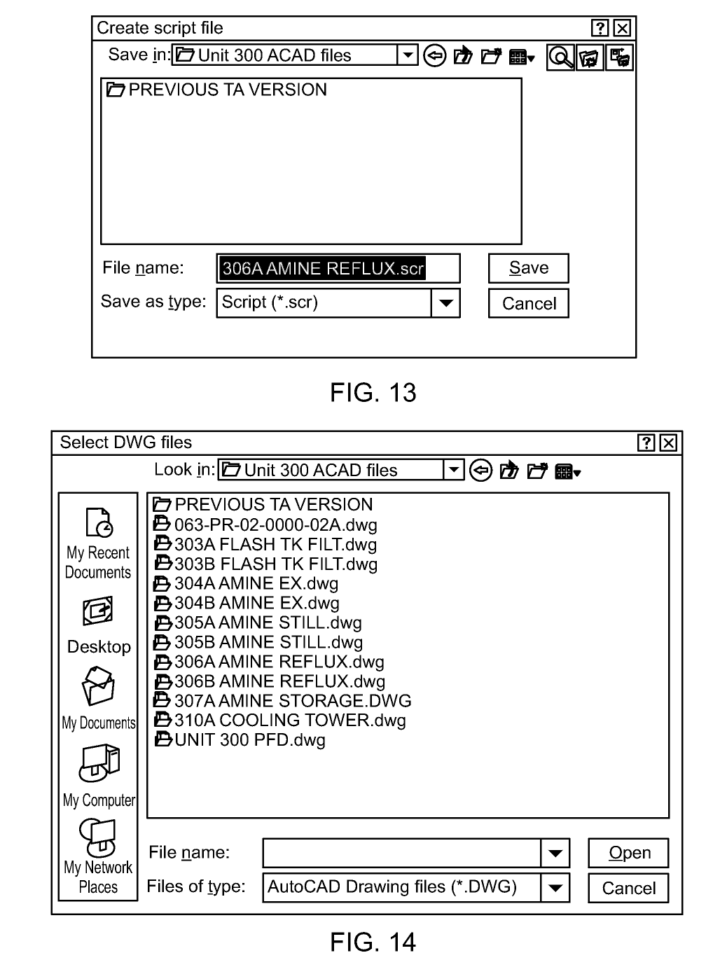

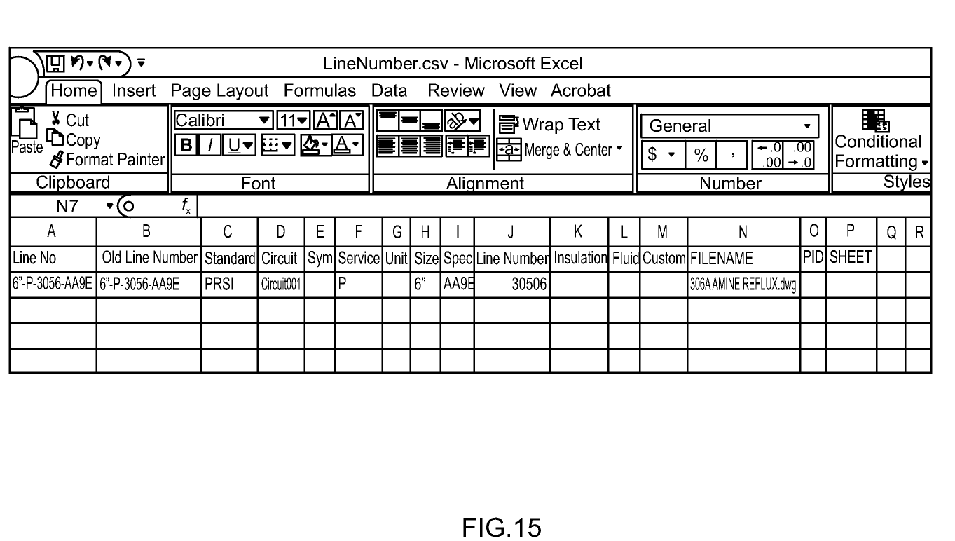

It is common for circuitization to be performed over multiple P&IDs. When the user selects the ‘Export All Lines Info’ button 76 of the circuitization toolbar 70 (see FIG. 6), a script file is generated that will create the export file. FIG. 13 shows a ‘Create Script File’ dialog box that allows the user to select a location where the script file will be saved. With input from the user, the application software 48 saves and executes the script file. When the script file is executed, the user sequentially selects all drawing files containing P&IDs from which pipe circuit data is to be extracted. FIG. 14 shows a ‘Select DWG Files’ dialog box that allows the user to select a drawing file containing a P&ID from which pipe circuit data is to be extracted. The ‘Select DWG Files’ dialog box appears again and again until the user selects the ‘Cancel’ button at the bottom of the dialog box, signaling the end of the drawing file selection process.

After the user has sequentially selected all the drawing files from which pipe circuit data is to be extracted, a spreadsheet file (e.g., a Microsoft Excel® compatible file) is created that serves as a database for all the pipe circuit data from the selected drawing files. FIG. 15 shows an image of an illustrative Excel® spreadsheet displayed on the display screen 16 of FIG. 1 and including the data for the created pipe circuit. In this simple example the only pipe circuit has circuit number ‘001’ and includes only one pipe—the pipe with line number ‘6″-P-30506-AA9E.’ The fields of the Excel® spreadsheet shown in FIG. 15 contain the line number of the pipe in the new data format and the original data formats, the designation of the new data format, and the characteristics defining the pipe (service, size, specification, and number). The exported file provides a condensed (yet precise) representation of the plant that can be efficiently employed by other software such as asset optimization software or maintenance scheduling software. Data from the exported file may be displayed to a user as part of a maintenance schedule or as part of an asset management plan.

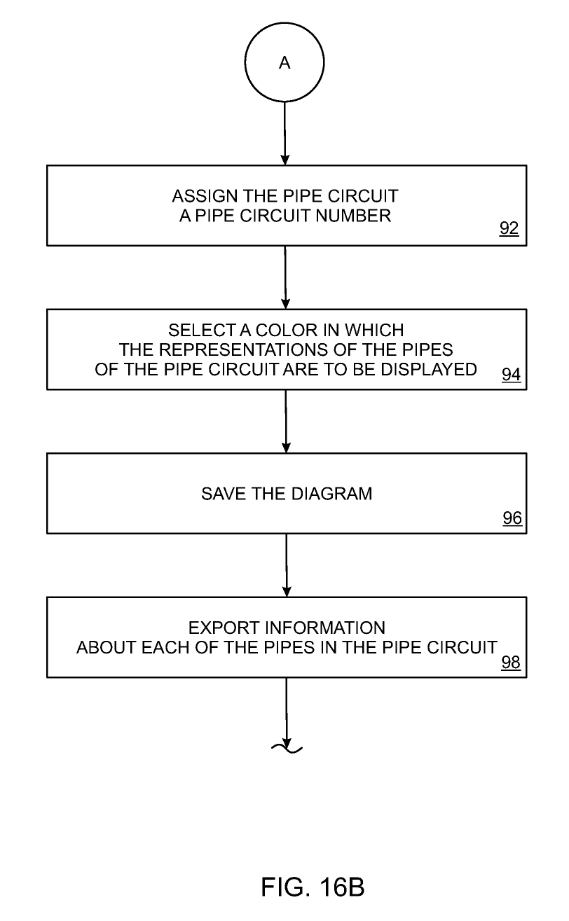

FIGS. 16A and 16B in combination form a flowchart of a method 80 for creating a pipe circuit. The method 80 may be carried out using the system 10 of FIG. 1. In a first step 82 of the method 80, a diagram (e.g., a P&ID) is displayed on a display screen (e.g., the display screen 16 of the computer system 12 of FIG. 1), where the diagram includes representations of multiple pipes to be included in the pipe circuit, and a line number corresponding to each of the pipes. During a decision step 84, a determination is made as to whether all of the line numbers corresponding to the pipes to be included in the pipe circuit are in a desired new data format. If one or more of the line numbers is not in the new data format, one of the line numbers not in the new data format is converted to the new data format during a step 86, and the decision step 84 is repeated. The step 86 is repeated until all of the line numbers corresponding to the pipes are converted to the new data format. As a result, if all of the line numbers are not in the new data format, the line numbers not in the new data format are converted one after another to the new data format.

When, during the decision step 84, all of the line numbers corresponding to the pipes to be included in the pipe circuit are in the new data format, a step 88 is performed. During the step 88, one of the pipes to be included in the pipe circuit is selected on the display screen. For example, during the step 88, the user of the computer system 12 of FIG. 1 may use the mouse 20 to select a representation of (e.g., a solid line representing) one of the pipes displayed on the display screen 16, and the application software 48 of FIG. 3 may receive selection input generated by the user and indicative of the selected pipe.

During a subsequent decision step 90, a determination is made as to whether all of the representations of the pipes to be included in the pipe circuit have been selected on the display screen. If any one of the representations of the pipes has not been selected on the display screen, the step 88 is repeated.

The step 88 is repeated until all of the representations of the pipes have been selected on the display screen. As a result, the representations of the pipes are selected on the display screen (e.g., on the display screen 16 of the computer system 12 of FIG. 1 by the user) one after another until all of the representations of the pipes to be included in the pipe circuit have been selected on the display screen.

When, during the decision step 90, all of the all of the representations of the pipes to be included in the pipe circuit have been selected on the display screen, a step 92 is performed. During the step 92, a pipe circuit number is assigned to the pipe circuit. For example, the application software 48 of FIG. 3 may assign the pipe circuit number to the pipe circuit based upon input from the user of the computer system 12 of FIG. 1. A color in which the representations of the pipes of the pipe circuit are to be displayed is selected during a step 94.

Following the step 94, the steps 84-94 may be repeated to define additional pipe circuits. For example, the pipe circuit assignment process of steps 84-94 may be repeated until many or all of the pipes in the displayed diagram have been assigned to different pipe circuits.

During a step 96, the diagram is saved (e.g., via the CAD software 60 as a drawing file in the memory 34 of the computer system 12 of FIG. 1). Information about each of the pipes in the pipe circuit is exported during a step 98. For example, the application software 48 of FIG. 3 may create spreadsheet file (e.g., a Microsoft Excel® file) that serves as a database for information about each of the pipes in the pipe circuit, and may save the spreadsheet file in the memory 34 of the computer system 12 of FIG. 1.

Numerous variations and modifications will become apparent to those skilled in the art once the above disclosure is fully appreciated. It is intended that the following claims be interpreted to embrace all such variations and modifications.

What is claimed is:

1. A computer system, comprising:
a display screen;
a memory containing instructions for:
displaying on the display screen a diagram including representations of a plurality of pipes to be included in the pipe circuit, and a line number corresponding to each of the pipes;
capturing engineering data from at least one of the displayed line numbers;
changing a display color of each of the representations of the pipes to a selected color; and
exporting information about each of the pipes in the pipe circuit to a database; and
at least one processor coupled to the memory and configured to fetch the instructions from the memory and to execute the instructions.

2. The computer system as recited in claim 1, wherein the instructions for capturing engineering data from at least one of the displayed line numbers comprise instructions for:
receiving input indicative of a current data format of a selected one of the line numbers;
parsing the line number to identify engineering data parameter values; and
storing the parameter values in a data structure that associates the parameter values with said pipe circuit.

3. The computer system as recited in claim 2, wherein the memory further contains instructions for:
saving the diagram in a file with the data structure.

4. The computer system as recited in claim 1, wherein the database comprises a spreadsheet file.

5. A circuitization method that comprises:
displaying at least a portion of a piping schematic for an industrial plant;
guiding a user through a circuitization process using a series of prompts;
gathering circuit information based on the user‘s responses; and
exporting the circuit information to a file.

6. The method of claim 5, wherein the user‘s responses include specifying a circuit identifier and selecting a set of one or more line numbers to be associated with that circuit identifier.

7. The method of claim 5, wherein the circuit information includes pipe size information that is extracted from said one or more line numbers.

8. The method of claim 5, wherein the user's responses include specifying a circuit identifier and selecting a set of one or more piping units to be associated with that circuit identifier.

9. The method of claim 5, further comprising displaying a highlight color around piping units that have been associated with a circuit identifier.

10. The method of claim 9, wherein different highlight colors are used to distinguish piping units associated with different circuit identifiers.

11. A method for creating a pipe circuit, comprising:
displaying on a display screen a diagram including representations of a plurality of pipes to be included in the pipe circuit, and a line number corresponding to each of the pipes;
receiving in sequence selection input indicative of each of the pipes; and
assigning the pipe circuit a pipe circuit number.

12. The method as recited in claim 11, further comprising:
converting at least one of the line numbers to a new data format.

13. The method as recited in claim 12, wherein the converting comprises:
receiving input indicative of a current data format of a selected one of the line numbers;
receiving input indicative of a new data format of the selected line number; and
converting the selected line number from the current data format to the new data format.

14. The method as recited in claim 11, further comprising:
receiving input indicative of a color in which the representations of the pipes of the pipe circuit are to be displayed.

15. The method as recited in claim 11, further comprising:
exporting information about each of the pipes in the pipe circuit to a database.

16. The method as recited in claim 15, wherein the database comprises a spreadsheet file.

17. A method for creating a pipe circuit, comprising:
displaying on a display screen a diagram including representations of a plurality of pipes to be included in the pipe circuit, and a line number corresponding to each of the pipes;
capturing engineering data from at least one of the displayed line numbers;
changing a display color of each of the representations of the pipes to a selected color; and
exporting information about each of the pipes in the pipe circuit to a database.

18. The method as recited in claim 17, further comprising converting at least one of the displayed line numbers to a new data format by:
receiving input indicative of a current data format of a selected one of the line numbers;
receiving input indicative of a new data format of the selected line number;
converting the selected line number from the current data format to the new data format; and
displaying the selected line number on the display screen according to the new data format.

19. The method as recited in claim 17, further comprising:
storing said engineering data in an internal data structure that associates said engineering data with said pipe circuit; and saving the diagram in a file that also includes said internal data structure.

20. The method as recited in claim 17, wherein the database comprises a spreadsheet file.
